(19) United States
(12) Patent Application Publication
(10) Pub. No.: US 2026/0005458 A1
(43) Pub. Date: Jan. 1, 2026

(54) MINIATURE ELECTRICAL RECEPTACLE CONTACT

(71) Applicant: LEMO SA, Ecublens (CH)

(72) Inventors: Jacques Miéville, Morrens (CH); Denis Miserez, Lausanne (CH); Ivan Francescut, Tannay (CH)

(73) Assignee: LEMO SA, Ecublens (CH)

(21) Appl. No.: 19/132,063

(22) PCT Filed: Nov. 6, 2023
(86) PCT No.: PCT/EP2023/080869

§ 371 Date: May 22, 2025

(30) Foreign Application Priority Data
Nov. 25, 2022 (EP) 22209687.7

(51) Int. Cl. H01R 13/11

(52) U.S. Cl. CPC H01R 13/11

(57) ABSTRACT

Miniature electrical receptacle contact formed integrally out of a single piece of conducting material configured for plugging connection in a linear axial plugging direction with a complementary pin contact having a diameter less than 2 mm, the receptacle contact comprising a plugging end section including a contact insertion cavity, a rim positioned at an entry end of the receptacle contact and extending fully around the contact insertion cavity, and a contact beam formed out of the plugging end section by a slot having an axial portion and a transverse portion such that the contact beam is cantilevered. The contact beam is attached to the rim proximal an entry face of the receptacle contact and extends to a free end formed by the transverse portion of the slot distal from the rim.

The present invention relates to a miniature electrical receptacle contact for mating with complementary pin contacts, the receptacle contact being machined out of a solid conductive body. The invention in particular relates to miniature electrical contacts where the receptacle contact has a diameter of the pin receiving cavity of less than 2 mm down to about 0.1 mm diameter.

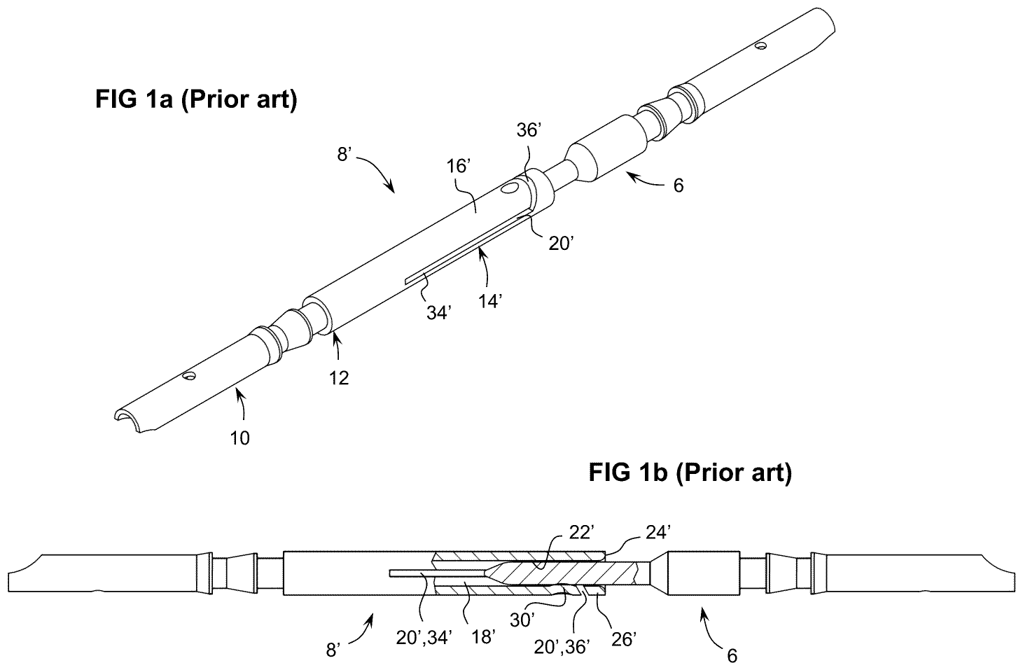

It is known to provide miniature receptacle contacts machined out of a solid metal body for high current density applications. In high current density applications or where reliability and safety is an important requirement, contacts machined out of a solid body of material formed as an integral contact are preferable over contacts that comprise stamped and formed parts that are assembled to a contact body. This is because contacts machined out of a solid body of a material present a lower resistance for the current between the contact section and cabling sections of the contact compared to assembled terminals with stamped and formed contact sections. FIGS. 1a and 1b illustrate a conventional receptacle contact machined from a solid body of conducting material, for instance copper based alloys, pluggably coupled to a pin contact. The receptacle contact 8′ extends between a wiring end section 10′ and a plugging end section 14′. The plugging end section 14′ comprises a contact beam 16′ and has a contact section 30′ at a free end of the beam that is proximate an entry section 22′ of the receptacle contact. The receptacle contact 8′ has a contact insertion cavity 18′ for pluggably receiving the pin contact 6 therein. In order to machine the receptacle contact 8′, the contact cavity is first bored with a milling or drilling tool and then a slot 20′ is cut out, the slot having a transverse portion 36′ and axial portion 34′ to form the beam 16′. The transverse portion 36′ is cut proximal an entry face 24′ of the receptacle contact 16′ and the beam is anchored at an axial position that is distal from the entry face 24′. Since the diameter of the bore needs to be slightly larger than the diameter D3 of the pin contact inserted therein, a forming operation is then required to plastically deform inwards the end of the contact beam 16′ such that it protrudes inwardly into the pin receiving cavity.

The forming operation however requires relatively complex manufacturing operations especially for miniature contacts in the range of 0.1 to 2 mm pin contact diameter and an outer receptacle body diameter of typically less than 3 to 4 mm. Complex operations include registering the position of the receptacle contact after the cutting operation in a forming machine and applying a precise amount of plastic deformation that is however hard to control because it is sensitive to variations in material properties and manufacturing tolerances. The variability in the elastic properties of the contact beam after the forming process means that larger safety margins are required in applications with high density currents and stringent safety specifications.

In view of the foregoing, it is an object of the invention to provide a miniature electrical receptacle contact that is able to support a high current density in a reliable manner.

It is advantageous to provide a miniature electrical receptacle contact that is economical to produce.

It is advantageous to provide a miniature electrical receptacle contact that is robust.

It is advantageous to provide a miniature receptacle contact that generates low plugging insertion force with a complementary male in contact.

Objects of this invention have been achieved by providing a system according to claim 1. Dependent claims set forth various advantageous features of embodiments of the invention.

Disclosed herein is a miniature electrical receptacle contact formed integrally out of a single piece of conducting material configured for plugging connection in a linear axial plugging direction with a complementary pin contact having a diameter less than 2 mm, the receptacle contact comprising a plugging end section including a contact insertion cavity, a rim positioned at an entry end of the receptacle contact and extending fully around the contact insertion cavity, and a contact beam formed out of the plugging end section by a slot having an axial portion and a transverse portion such that the contact beam is cantilevered. The contact beam is attached to the rim proximal an entry face of the receptacle contact and extends to a free end formed by the transverse portion of the slot distal from the rim.

In an advantageous embodiment, the contact insertion cavity is milled or drilled, and comprises an entry section having a diameter D1 and a contact section having a diameter D2 smaller than the entry section diameter D1, the entry section connected to the contact section via a taper or chamfer portion whereby the intersection between the chamfer portion and contact portion forms the contact points between the contact beam and the complementary pin contact.

In an advantageous embodiment, the slot is produced by subtractive manufacturing techniques.

In an advantageous embodiment, the slot is machined with a cutting tool.

In an advantageous embodiment, an axial length L2 of the contact beam from the rim to the contact points is in a range of 1.5 to 4 times the contact section diameter D2.

In an advantageous embodiment, the rim has an axial length L1, the axial direction being the direction of the axis of the contact insertion cavity, which is in a range of 0.5 to 1.5 times the contact section diameter D2.

In an advantageous embodiment, the contact insertion cavity has an overall length L3 greater than a sum of the length of the transverse portion of the slot, the contact beam and the rim, such that the contact insertion cavity extends into a centre body portion of the receptacle contact.

In an embodiment, a maximum outer diameter D4 of the receptacle contact is less than 4 mm.

In an embodiment, a maximum outer diameter D4 of the receptacle contact is less than 3 mm.

In an embodiment, the contact section diameter D2 is less than 1.5 mm.

In an embodiment, the contact section diameter D2 is less than 1 mm.

Also disclosed herein is an electrical receptacle contact in combination with an electrical pin contact, the pin contact having a contact portion having a diameter D3 greater than the diameter D2 of the contact section and smaller than a diameter D1 of the entry section.

In an advantageous embodiment, the contact cavity length L3 is more than 2 times, preferably more than 3 times a beam length to contact point L2.

Also disclosed herein is an electrical connector comprising an insulating housing having contact receiving cavities herein, and a plurality of electrical receptacle contacts according to anyone of the preceding claims lodged within the contact receiving cavities.

In an embodiment, the plurality of receptacle contacts have a contact density, seen in cross-section orthogonal to the plugging direction, of greater than 8 contacts per square centimeter.

Further objects and advantageous features of the invention will be apparent from the claims, from the detailed description, and annexed drawings, in which:

FIG. 1a is a perspective view of a prior art miniature receptacle contact machined from a single piece of conducting material pluggably coupled to a pin contact;

FIG. 1b is a side partial cross-sectional view of the prior art contact arrangement of FIG. 1a;

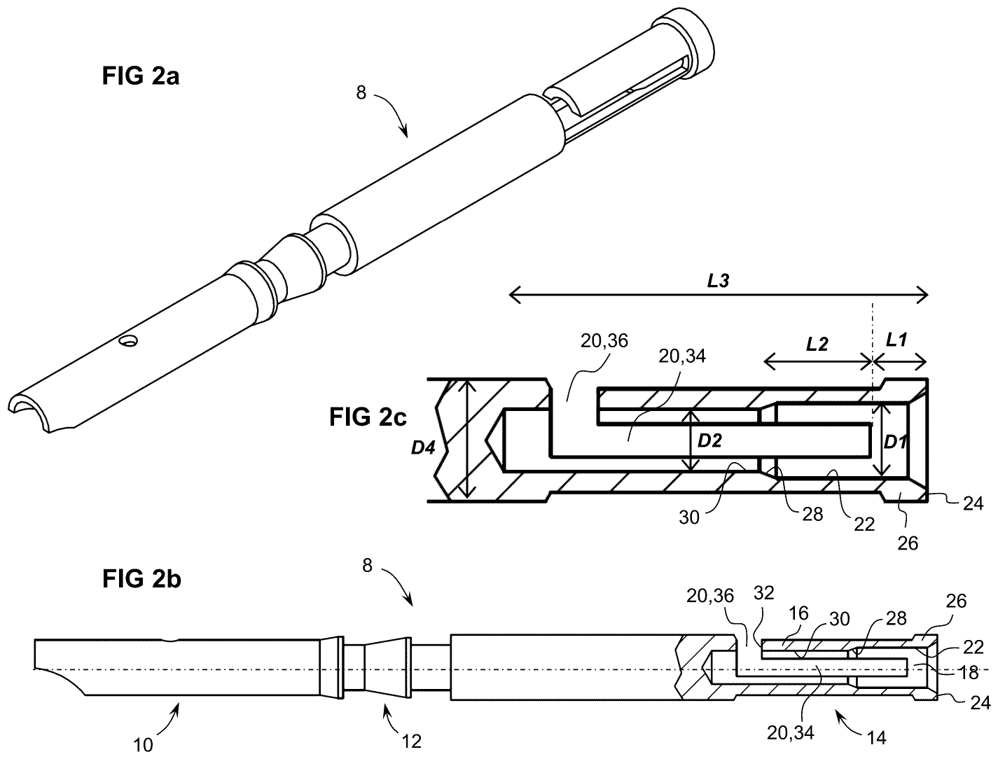

FIG. 2a is a perspective view of a miniature receptacle contact according to an embodiment of the invention;

FIG. 2b is a side partial cross-sectional view of the receptacle contact of FIG. 2a;

FIG. 2c is a detail portion of a contact section of the receptacle contact of FIG. 2b;

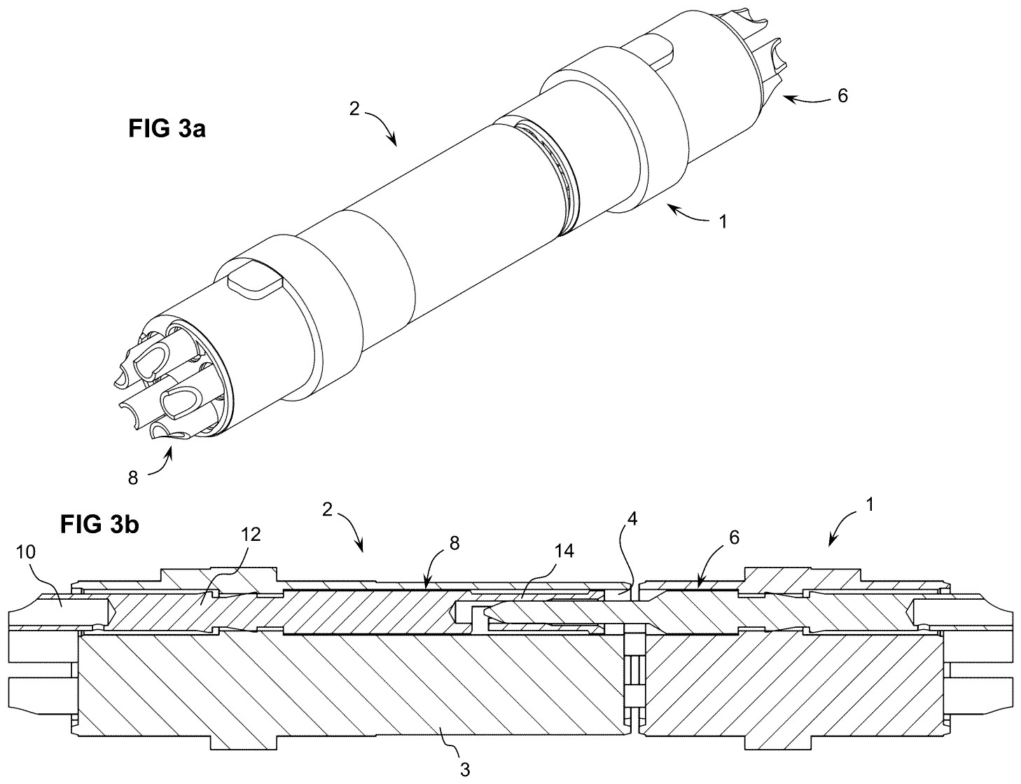

FIG. 3a is a perspective view of an electrical connector arrangement comprising pluggably connected male and female connectors, the female connector comprising electrical receptacle contacts according to an embodiment of the invention;

FIG. 3b illustrates a cross-sectional side view of the connector arrangement of FIG. 3a;

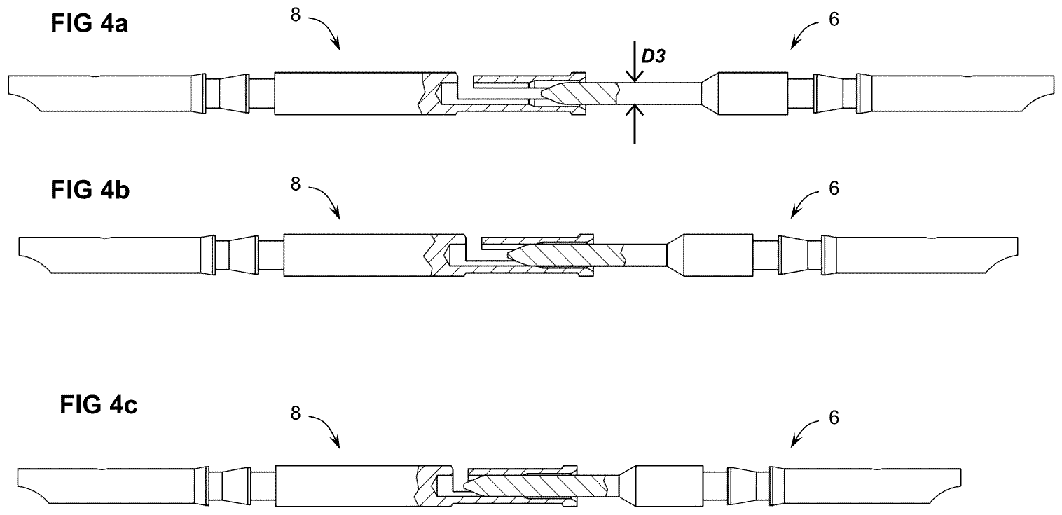

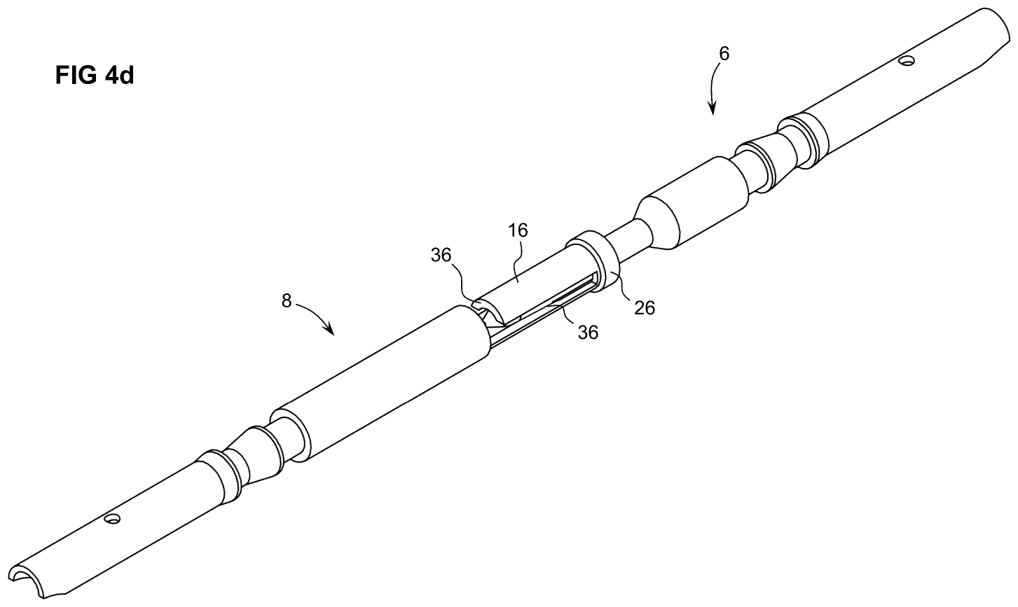

FIGS. 4a to 4c illustrate plugging insertion of a male pin contact into a receptacle contact according to an embodiment of the invention, a contact section being shown in cross-section;

FIG. 4d shows a perspective view of the pin contact mated to the receptacle contact according to an embodiment of the invention.

Referring to FIGS. 2a to 4d, an embodiment of a receptacle contact according to an embodiment of the invention will now be described.

Referring first to FIGS. 3a and 3b, an electrical connector arrangement comprises a female connector 1 and a male connector 2 pluggably connected together. The female connector 1 comprises a housing 3 and a plurality of electrical receptacle contacts 8 mounted in contact receiving cavities 4 in the housing 3. The diameter or size of the connector arrangement will depend on the number of contacts and the voltage and current requirements whereby in many applications it is a general desire to have connectors that are compact without reducing the required reliability or performance requirements. High density yet high reliability and safety requirements may be found, for instance in medical applications or various other sensing and information transmission applications, for instance in aeronautical applications. The miniature contacts of the present invention typically have an outer diameter that is less than 3 mm and often less than 2 mm, for instance in the range of 0.5 to 2.5 mm outer diameter. The resistance to current of miniature contacts of the present invention is typically less than 0.005 Ohms, which allows to carry higher current densities compared to comparable sized conventional contacts with assembled and stamped and formed contact portions.

A connector comprising a plurality of miniature contacts according to embodiments of the invention may for instance have a contact density (seen in cross-section orthogonal to the plugging direction) of greater than 3 contacts per square centimetre, for instance between 8 to 16 contacts per square centimetre.

In applications where a large number of contacts are required, for instance more than 8 contacts, the plugging insertion force of the male and female connectors is also an important consideration, whereby the individual mating pin and receptacle contact insertion force is an important factor in the global plugging force. As will be described in more detail hereinafter, the plugging force of the pin contact inserted in a receptable contact according to embodiments of the invention is lower than the prior art illustrated in FIGS. 1a and 1b for equivalent performance, namely the rated current that may flow through the contact of equivalent dimensions.

The electrical receptacle contact 8 comprises a wiring end section 10 for connection to an external conductor, which in the present example is configured for connection to a conducting wire. The wiring end section 10 may however be configured for connection to a circuit board or may have a plugging type connection such as a receptacle contact section or pin contact section for further connection to a complementary electrical terminal. The electrical receptacle contact 8 extends from the wiring end section 10 to a plugging end section 14 configured for plugging connection with a complementary pin contact 6. For receptacle contacts with an overall length that is much greater than an overall diameter of the receptacle contact, a centre body section 12 may be provided with a length adjusted for the overall desired length of the receptacle contact.

The receptacle contact is formed of a single integral piece of conducting material, preferably of a metal, for instance of copper based alloys or other materials that are per se well known for machined single part contacts. The contact is manufactured typically from a rod from which material is removed in turning, milling and cutting operations, such operations being per se well known in the art. Various features may be machined in the body of the material for positioning and fixing the receptacle contact in an insulating material, in particular a cavity formed in an insulating housing of an electrical connector. A maximum overall diameter of the receptacle contact 8 is illustrated as diameter D4 whereby for miniature contacts within the scope of this invention D4 is less than 4 mm, typically less than 3.5 mm and may be in a range of 0.5 to 3 mm, for instance in a range of 0.8 to 2 mm.

The diameter D3 of the contact portion of the mating pin contact 6 is typically in a range of 30 to 60% of the overall maximum diameter D4 of the receptacle contact. The plugging end section of the receptacle comprises a contact beam 16 that is attached to a rim 26 at an entry end of the contact and extends rearwardly towards the centre body section 12. A contact insertion cavity 18 for receiving the electrical pin contact 6 extends into the plugging end section 14 over a contact cavity length L3.

The contact insertion cavity comprises an entry section 22 having a diameter D1 that is slightly greater than a diameter D3 of the pin contact configured to be inserted in the receptacle contact. The contact insertion cavity further comprises a contact section 30 having a diameter D2 that is smaller than the entry section diameter D1 and slightly smaller than the diameter D3 of the pin contact. A tapered or chamfered portion 28 interconnects the entry section 22 to the contact section 30.

The contact beam 16 is formed out of the body of the contact by a slot 20 having an axial portion 34 extending parallel or substantially parallel to a longitudinal axis A that corresponds to the plugging insertion direction of the pin contact in the receptacle contact, and a transverse portion 36 that extends transversally cutting through the tubular wall of the plugging end section until it meets the transverse portion in order to form the cantilever contact beam 16.

The rim 26 is provided with a certain length L1 sufficient for structural integrity of the rim to support the elastic forces applied on the cantilever contact beam 16 during plugging insertion of the pin contact.

The position of the chamfer or taper 28 may be configured to define a length L2 from the end of the longitudinal slot where the contact with the pin should occur. This defines the active length of the cantilever beam that is subject to bending stress when the pin is inserted. The remaining length of the cantilever beam may serve a protective or covering function to cover the contact insertion cavity 18 which may be useful during handling and manufacturing of the contact to avoid the contacts interlocking or catching onto other objects.

The end section 32 of the contact insertion cavity 18 extends into the material of the centre body section 12, beyond the transverse portion 36 of the slot 20, for receiving the tip of the pin contact. The end section 32 may serve as a protection against an excessive bending force applied on the mated contacts and potentially to centre the pin contact relative to the contact insertion cavity.

Advantageously, in comparison to the miniature machined prior art contact illustrated in FIGS. 1a and 1b, the miniature contact according to embodiments of this invention may be produced without requiring any deformation or bending operations on the elastic contact arm 16, thus not only simplifying manufacturing procedures but also allowing more accurate repeatable plugging contact forces when inserting a pin contact in the receptacle contact. This is because the machining of the contact insertion cavity 18 by a boring, milling or drilling operation can be performed with very high precision and is not reliant on the plastic deformation of the contact beam. Moreover, the contact force can be easily varied as a function of the application and requirements by simply varying the contact cavity section diameter D2 and/or length L2 of the entry section 22 thus displacing the position of the chamfer 28 that determines the contact points.

The plugging insertion forces are easier to adjust accurately because of the more accurate tolerances in the position of the contact points and thus the elastic beam strength of the contact beam. In the prior art configuration illustrated in FIGS. 1a and 1b when the contact beam pivots there is a small displacement component that is in the opposite direction to the insertion of the pin, whereas in the invention configuration as the contact beam rotates the axial displacement component is either essentially zero or sightly in the plugging direction.

The plugging force is thus within a narrower band of variability than in the prior art solution while ensuring a well defined contact force and thus a well defined current carrying capability.

List of references used

```
Electrical male connector 1
    Electrical pin contact 6
Electrical female connector 2
  Housing 3
      Contact receiving cavity 4
  Electrical receptacle contact 8
      Wiring end section 10
      Centre body section 12
      Plugging end section 14
        Contact beam 16
        Rim 26
        Contact insertion cavity 18
          Entry section 22
            Entry face 24
          Chamfer 28
          Contact section 30
          Free end section 32
        Slot 20
          Axial portion 34
          Transverse portion 36
Contact cavity entry section diameter D1
Contact cavity contact section diameter D2
Pin contact diameter D3
Receptacle contact body diameter D4
Entry section length to slot L1
Beam length to contact point L2
Contact cavity length L3
Electrical receptacle contact 8′ (prior art)
      Wiring end section 10
      Centre body section 12
      Plugging end section 14′
        Contact beam 16′
        Contact insertion cavity 18′
          Entry section 22′
            Entry face 24′
            Rim 26′
          Contact section 30′
        Slot 20′
          Axial portion 34′
          Transverse portion 36′
```

1.-15. (canceled)

16. Miniature electrical receptacle contact formed integrally out of a single piece of conducting material configured for plugging connection in a linear axial plugging direction with a complementary pin contact having a diameter less than 2 mm, the receptacle contact comprising a plugging end section including a contact insertion cavity, a rim positioned at an entry end of the receptacle contact and extending fully around the contact insertion cavity, and a contact beam formed out of the plugging end section by a slot having an axial portion and a transverse portion such that the contact beam is cantilevered, wherein the contact beam is attached to the rim proximal an entry face of the receptacle contact and extends to a free end formed by the transverse portion of the slot distal from the rim.

17. Receptacle contact according to claim 16, wherein the contact insertion cavity is milled or drilled, and comprises an entry section having a diameter D1 and a contact section having a diameter D2 smaller than the entry section diameter D1, the entry section connected to the contact section via a taper or chamfer portion whereby the intersection between the chamfer portion and contact portion forms the contact points between the contact beam and the complementary pin contact.

18. Receptacle contact according to claim 16, wherein the slot is produced by subtractive manufacturing techniques.

19. Receptacle contact according to claim 18, wherein the slot is machined with a cutting tool.

20. Receptacle contact according to claim 16, wherein an axial length L2 of the contact beam from the rim to the contact points is in a range of 1.5 to 4 times the contact section diameter D2.

21. Receptacle contact according to claim 16, wherein the rim has an axial length L1, the axial direction being the direction of the axis of the contact insertion cavity, which is in a range of 0.5 to 1.5 times the contact section diameter D2.

22. Receptacle contact according to claim 16, wherein the contact insertion cavity has an overall length L3 greater than a sum of the length of the transverse portion of the slot, the contact beam and the rim, such that the contact insertion cavity extends into a centre body portion of the receptacle contact.

23. Receptacle contact according to claim 16, wherein a maximum outer diameter D4 of the receptacle contact is less than 4 mm.

24. Receptacle contact according to claim 23, wherein a maximum outer diameter D4 of the receptacle contact is less than 3 mm.

25. Receptacle contact according to claim 16, wherein the contact section diameter D2 is less than 1.5 mm.

26. Receptacle contact according to claim 25, wherein the contact section diameter D2 is less than 1 mm.

27. Electrical receptacle contact according to claim 16, in combination with an electrical pin contact, the pin contact having a contact portion having a diameter D3 greater than the diameter D2 of the contact section and smaller than a diameter D1 of the entry section.

28. Receptacle contact according to claim 16, wherein the contact cavity length L3 is more than two times, preferably more than three times a beam length to contact point L2.

29. Electrical connector comprising an insulating housing having contact receiving cavities therein, and a plurality of electrical receptacle contacts according to claim 16, lodged within the contact receiving cavities.

30. Electrical connector according to claim 29, wherein the plurality of receptacle contacts have a contact density, seen in cross-section orthogonal to the plugging direction, of greater than 8 contacts per square centimetre.
